(19) United States
(12) Patent Application Publication
(10) Pub. No.: US 2019/0138990 A1
(43) Pub. Date: May 9, 2019

(54) MAINTAINING FLEET VEHICLE RECORDS

(71) Applicant: Ford Global Technologies, LLC, Dearborn, MI (US)

(72) Inventors: Jamal Alezzani, Dearborn, MI (US); Vishnu Swaroop, Detroit, MI (US)

(73) Assignee: Ford Global Technologies, LLC, Dearborn, MI (US)

(21) Appl. No.: 15/808,661

(22) Filed: Nov. 9, 2017

(51) Int. Cl. G06Q 10/10

(52) U.S. Cl. CPC G06Q 10/10; G06Q 10/06313; G06Q 2220/00

(57) ABSTRACT

A system and method are described. A method may include: receiving, from a requesting computer, a current transaction request for use of at least one vehicle in a fleet; determining that each of a plurality of stakeholder systems approves the request; generating a new record indicating approval of the use by cryptographically linking the new record to a previous record associated with a different transaction request; and sending an indication of approval to the requesting computer.

### BACKGROUND

An owner of a fleet of vehicles which may be rented, leased, or otherwise used needs to maintain records of transactions, vehicle service, etc. One fleet management problem is to generate and securely maintain records for the vehicle fleet.

### BRIEF DESCRIPTION OF THE DRAWINGS

FIG. 1 is a schematic diagram illustrating a communication network that comprises a plurality of computing systems, wherein one of the computing systems is a fleet manager system that manages a fleet of vehicles.

FIGS. 2-3 illustrate a flow diagram of a process which may be executed by the fleet manager system to generate and maintain vehicle fleet records.

### DETAILED DESCRIPTION

A communication network is described that includes a plurality of computing systems, wherein one of the computing systems may be a fleet manager system. The fleet manager system may include a computer which is configured to execute instructions which enable the fleet manager system, along with the other computing systems in the communication network, to generate and securely maintain records associated with the vehicles in the fleet.

According to one example, a method comprises: receiving, from a requesting computer, a current transaction request for use of at least one vehicle in a fleet; determining that each of a plurality of stakeholder systems approves the request; generating a new record indicating approval of the use by cryptographically linking the new record to a previous record associated with a different transaction request; and sending an indication of approval to the requesting computer.

According to the at least one example set forth above, the current transaction request is received by a fleet manager system, wherein the fleet manager system is one of the plurality.

According to the at least one example set forth above, the new record and the previous record are part of a blockchain of records.

According to the at least one example set forth above, the new record comprises a hash of: the previous record and data indicating an approval from each of the plurality.

According to the at least one example set forth above, with respect to the previous record, the new record is a next-most-recent record generated by the plurality.

According to the at least one example set forth above, each of the plurality approve in accordance with a unique vehicle usage policy.

According to the at least one example set forth above, a fleet manager system approves in accordance with a vehicle usage policy, wherein the fleet manager system is one of the plurality.

According to the at least one example set forth above, the request identifies a vehicle model, wherein the policy includes determining whether a fleet inventory includes the model and whether the model is available.

According to the at least one example set forth above, the request identifies a pick-up location and a pick-up time, wherein the policy includes determining whether one of a fleet inventory is capable of arriving at the pick-up location timely.

According to the at least one example set forth above, further comprising, in accordance with the policy, determining whether each of a fleet inventory includes up-to-date government vehicle registration.

According to the at least one example set forth above, further comprising determining whether a driving record of a user is in accordance with the policy.

According to another illustrative example, a method comprises: storing, at a fleet manager system, a previous record associated with a previous transaction; receiving, from a requesting computer, a transaction request for use of a fleet vehicle; evaluating request data, from the transaction request, to determine whether it conforms to a vehicle usage policy; transmitting, to at least one additional stakeholder system, a request message comprising at least some of the request data, wherein a plurality of stakeholders comprise the fleet manager system and the at least one additional stakeholder system; determining that the plurality approves the request; transmitting, to the requesting computer, a response indicating the request for use of the vehicle is approved; and storing a new record based on a unanimous approval, wherein the new record is linked to the previous record.

According to the at least one example set forth above, the new record and the previous record are part of a blockchain of records.

According to the at least one example set forth above, the new record comprises a hash of: the previous record and data indicating an approval from each of the plurality.

According to the at least one example set forth above, with respect to the previous record, the new record is a next-most-recent record generated by the plurality.

According to the at least one example set forth above, the request identifies a vehicle model, wherein the policy includes determining whether a fleet inventory includes the model and whether the model is available.

According to the at least one example set forth above, the request identifies a pick-up location and a pick-up time, wherein the policy includes determining whether one of a fleet inventory is capable of arriving at the pick-up location timely.

According to the at least one example set forth above, further comprising, in accordance with the policy, determining whether each of a fleet inventory includes up-to-date government vehicle registration.

According to the at least one example set forth above, further comprising determining whether a driving record of a user is in accordance with the policy.

According to another illustrative example, a fleet manager system comprises: a processor; and memory storing instructions executable by the processor, the instructions comprising, to: store, at a fleet manager system, a previous record associated with a previous transaction; receive, from a requesting computer, a transaction request for use of a fleet vehicle; evaluate request data, from the transaction request, to determine whether it conforms to a vehicle usage policy; transmit, to at least one additional stakeholder system, a request message comprising at least some of the request data, wherein a plurality of stakeholders comprise the fleet manager system and the at least one additional stakeholder system; determine that the plurality approves the request; transmit, to the requesting computer, a response indicating the request for use of the vehicle is approved; and store a new record based on a unanimous approval, wherein the new record is linked to the previous record.

According to the at least one example, a computer is disclosed that is programmed to execute any combination of the examples set forth above.

According to the at least one example, a computer is disclosed that is programmed to execute any combination of the examples of the method(s) set forth above.

According to the at least one example, a computer program product is disclosed that includes a computer readable medium storing instructions executable by a computer processor, wherein the instructions include any combination of the instruction examples set forth above.

According to the at least one example, a computer program product is disclosed that includes a computer readable medium that stores instructions executable by a computer processor, wherein the instructions include any combination of the examples of the method(s) set forth above.

Now turning to the figures, wherein like numerals indicate like or identical parts throughout the several views, there is shown a communication network 10 adapted to manage a fleet of vehicles 12 (e.g., only one vehicle in the fleet is shown for purposes of illustration). The network 10 may comprise a plurality of stakeholder systems 14, 16, 18, 20, 22, 24, 26 that, for the fleet of vehicles 12, determine whether to approve requested transactions and/or generate records of the respective transactions. According to an example, the fleet vehicles 12 may be so called vehicle-as-a-service (VaaS) vehicles that are managed using stakeholder system 14 (e.g., also referred to as fleet manager system 14). Fleet manager system 14 controls the operations associated with each of the vehicles 12. The fleet manager system 14 may be used and/or controlled by a fleet manager—e.g., which may be a vehicle manufacturer, a car or vehicle agency, or the like entity.

According to one example, VaaS vehicles may be used by human end-users, wherein at least one of the end-users has no right of ownership and no right of possession of the respective vehicle—e.g., rather a license to use under certain circumstances. According to some VaaS scenarios, one end-user (e.g., an operator) may have a right of ownership and/or possession, and that end-user may pick up and drop off other end-users (e.g., passengers) who do not possess such rights. For example, the passengers may be invitees (i.e., a person who is invited into the vehicle by the operator (and/or the fleet manager) as a member of the public or a person who is invited to into the vehicle 12 for the purpose of business dealings with the operator and/or the fleet manager). In at least some examples, the operator is compensated by the fleet manager for offering his/her personal vehicle 12 for ride-share purposes.

According to another VaaS vehicle example, the vehicle 12 does not have a human operator—e.g., all end-users may be passengers. For instance, as described more below, the vehicle 12 may be a fully autonomous fleet vehicle—e.g., servicing passengers as an autonomous taxi. In these instances, the vehicle 12 may communicate with the fleet manager system 14 to determine whether, when, and where to pick-up passenger(s), where to drop off the passenger(s) which have been picked up, whether to permit the vehicle 12 to be utilized for a particular purpose, and the like—as also will be described more below.

According to yet another VaaS vehicle example, the vehicle 12 may transport goods instead of (or in addition to) transporting passengers. For example, one or more of the VaaS vehicles in the fleet may provide an autonomous vehicle delivery service. In still other examples, a VaaS vehicle may perform a service by driving without passengers or cargo—e.g., as a traveling advertisement, as an imaging unit (e.g., gathering camera, LiDar, and other data used to generate localization models), etc.

It should be appreciated that the fleet of vehicles 12 may comprise one or more different types of VaaS vehicles. For example, the fleet may comprise a single type of VaaS vehicles or it could comprise a plurality of mix-use types of VaaS vehicles.

As will be described in detail below, in order to generate and securely maintain vehicle records, fleet manager system 14 may acquire the approval of the other stakeholder systems 16-26 in the communication network 10. In at least some instances, a transaction is initiated by a request (e.g., which may originate via a third-party computer or via one of the stakeholder systems 14-26). The transaction request may be analyzed by each of the stakeholder systems 14-26. Each of the stakeholder systems may determine whether to approve based on a unique vehicle usage policy (e.g., a set of predefined rules—which may be based on or derived from a contract or mutual agreement between the entities controlling the respective stakeholder systems 14-26). According to one example, some of the stakeholder system policies may permit the respective stakeholder system to approve when a new transaction request does not conflict with one of their previous reservations for one or more fleet vehicles 12. Some policies may permit the stakeholder system to approve based on determining that a respective vehicle has up-to-date government vehicle registration, up-to-date insurance coverage, or the like. Some policies may permit the stakeholder system to approve based on determining that a driver of a respective vehicle has up-to-date government licensing, has a driving record better than a threshold, or the like. Other policy examples will be described below (by way of example).

When unanimous approval among the stakeholder systems within the network 10 is determined, then the vehicle 12 may be used for the requested purpose and a new record may be generated. As will be explained in detail below, this new record may be linked to a previous record (which previous record may be linked to a still-earlier record). For example, in one instance, the new record may be linked cryptographically to a next-most-recent record, which next-most-recent record was previously linked cryptographically to its previous and next-most-recent record, etc.

According to one example, when each stakeholder system 14-26 approves the transaction, then the vehicle 12 may be used for the requested purpose or according to the requested manner. And when at least one of the stakeholder systems 14-26 does not approve the requested transaction, then the vehicle 12 may not be used for the requested purpose or according to the requested manner. In some examples, a record is generated for approved transactions. In other examples, a record is generated for all transactions, regardless of whether they are approved or denied.

The fleet vehicles 12 will be described first. Then, stakeholder systems 14-26 will be described. Thereafter, several exemplary interactions of the stakeholder systems 14-26 and the fleet vehicle(s) 12 will be discussed.

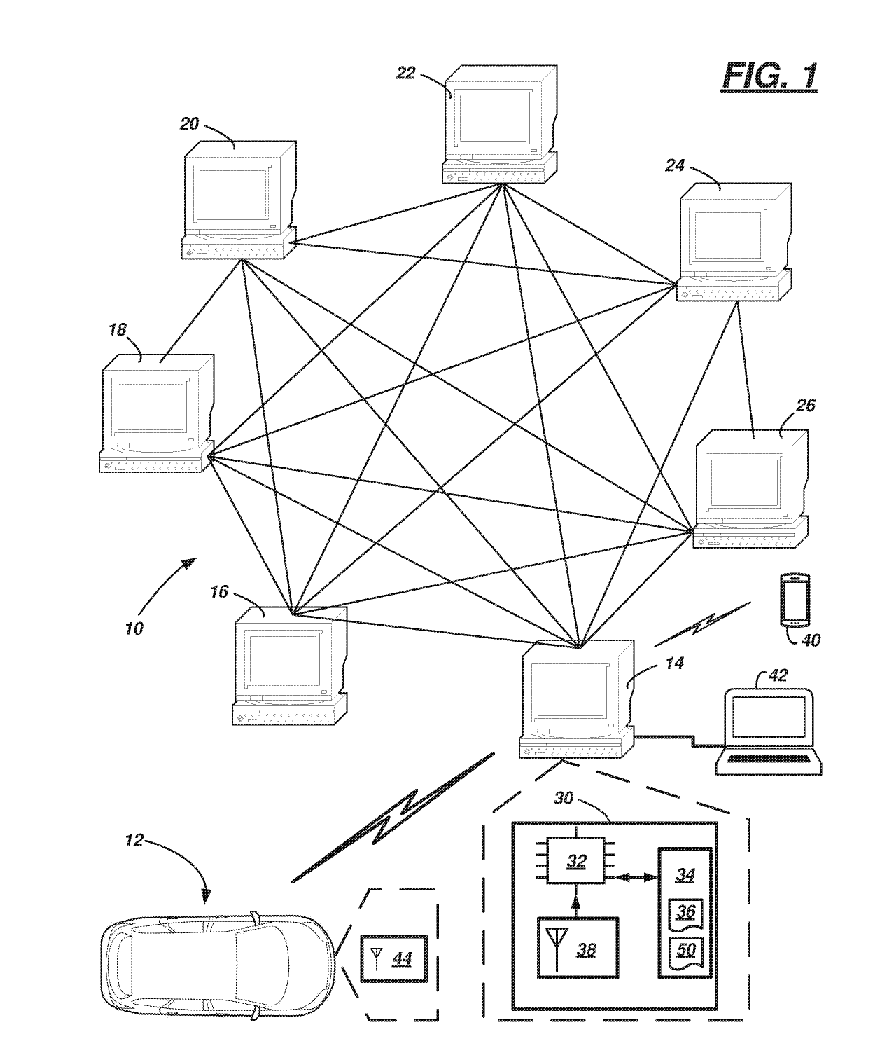

Vehicle 12 shown in FIG. 1 may be any one of a number of VaaS vehicles in the fleet. In at least one example, a number of features of the vehicles 12 may be similar or identical; accordingly, only one will be described herein. Vehicle 12 is shown as a passenger car; however, vehicle 12 could also be a truck, sports utility vehicle (SUV), tractor-trailer vehicle, recreational vehicle, bus, manned aircraft, unmanned aerial vehicle (UAV or drone), the like, or even a combination thereof.

In at least one example, vehicle 12 is operable in one of a plurality of autonomous modes; and in at least one example, vehicle 12 is operable in a fully autonomous mode—e.g., operating at an autonomous mode level 5, as defined by the Society of Automotive Engineers (SAE) (which has defined operation at levels 0-5). For example, at levels 0-2, a human driver monitors or controls the majority of the driving tasks, often with no help from the vehicle 12. For example, at level 0 (“no automation”), a human driver is responsible for all vehicle operations. At level 1 (“driver assistance”), the vehicle 12 sometimes assists with steering, acceleration, or braking, but the driver is still responsible for the vast majority of the vehicle control. At level 2 (“partial automation”), the vehicle 12 can control steering, acceleration, and braking under certain circumstances without human interaction. At levels 3-5, the vehicle 12 assumes more driving-related tasks. At level 3 (“conditional automation”), the vehicle 12 can handle steering, acceleration, and braking under certain circumstances, as well as monitoring of the driving environment. Level 3 may require the driver to intervene occasionally, however. At level 4 (“high automation”), the vehicle 12 can handle the same tasks as at level 3 but without relying on the driver to intervene in certain driving modes. At level 5 (“full automation”), the vehicle 12 can handle all tasks without any driver intervention. For example, as discussed above, vehicle 12 may operate as an autonomous taxi or the like.

Vehicle 12 may be equipped with vehicle electronics and other equipment (not shown) which facilitate a short- and/or long-range wireless communication. For example, vehicle 12 may comprise an onboard telematics device enabling cellular communication, dedicated short-range communication (DSRC), vehicle-to-vehicle (V2V) communication, vehicle-to-infrastructure (V2I) communication, or the like. Such vehicle electronics and wireless communication equipment is known in the art. In this manner, vehicle 12 may be responsive to wireless instructions sent from the fleet manager system 14 or other entity. Furthermore, in some examples, vehicle 12 may send requests to communication network 10—e.g., prompted by a user or based on computerized triggers programmed into the computing systems onboard the respective vehicle.

Turning now to communication network 10 which comprises the plurality of stakeholder systems 14-26. Each stakeholder system 14-26 may have similar or identical hardware; therefore, only the hardware of one will be described.

Stakeholder system 14 (e.g., fleet manager system 14) may comprise one or more computers operating over an intranet or other secure telecommunication network. Typically, each stakeholder system is associated with and controlled by a different entity. For example, system 14 may be controlled and operated by a fleet manager, as described above. For purposes of illustration only, system 16 may be controlled and operated by a government entity (e.g., such as a law enforcement department), system 18 may be controlled and operated by a financial institution or entity (e.g., such as a bank or credit union), system 20 may be controlled and operated by another business or entity (e.g., such as a florist), system 22 may be controlled and operated by a mail or parcel delivery entity (e.g., such as the United States Postal Service, a non-government-owned parcel delivery organization, or the like), system 24 may be controlled and operated by yet another business entity (e.g., a restaurant or catering service), and system 26 may be controlled and operated by yet another business entity (e.g., an insurance agency providing and/or managing vehicle insurance policy information and coverage). As described above, each stakeholder system 14-26 may have an interest in the use or operation of vehicles 12—e.g., whether the vehicles 12 are licensed and insured, whether (when present) a driver is properly licensed, whether the driver has a good or poor driving record, whether an end-user has a criminal record, outstanding warrants, etc., for what type of use the vehicles 12 may be used (e.g., delivering of food, parcels, heavy or large shipments, etc.), and the like.

For purposes of illustration, FIG. 1 illustrates fleet manager system 14 comprising a single computer 30 that comprises at least one processor 32 and memory 34. Again, it should be appreciated that in at least one example, fleet manager system 14 could comprise multiple computers networked to one another. And for purposes of illustration, one processor is shown. Where multiple processors are used, each processor may be identical (in at least one example); therefore, only one will be described herein. Processor 32 can be any type of device capable of processing electronic instructions, non-limiting examples including a microprocessor, a microcontroller or controller, an application specific integrated circuit (ASIC), etc.—just to name a few. As discussed below, processor 32 may execute digitally-stored instructions 36 (stored in memory 34) which, among other things, define how the stakeholder systems 14-26 communicate and interact with one another.

Memory 34 may include any non-transitory computer usable or readable medium, which may include one or more storage devices or articles. Exemplary non-transitory computer usable storage devices include conventional hard disk, solid-state memory, random access memory (RAM), read-only memory (ROM), erasable programmable read-only memory (EPROM), electrically erasable programmable read-only memory (EEPROM), as well as any other volatile or non-volatile media. Non-volatile media include, for example, optical or magnetic disks and other persistent memory, and volatile media, for example, also may include dynamic random access memory (DRAM). These storage devices are non-limiting examples; e.g., other forms of computer-readable media exist and include magnetic media, compact disc ROM (CD-ROMs), digital video disc (DVDs), other optical media, any suitable memory chip or cartridge, or any other medium from which a computer can read. As discussed above, memory 34 may store one or more computer program products which may be embodied as software, firmware, or other programming instructions executable by the processor 32.

According to one example, each stakeholder system 14-26 may store in respective computer memory a unique public key and private key pair (e.g., according to a public key infrastructure (PKI)), and each stakeholder system 14-26 may store in respective computer memory a common (or same) symmetric key. As will be explained more below, these keys may be used to validate communications sent between the respective systems 14-26, to generate new records, securely maintain records, and to determine whether a security breach has occurred.

Computer 30 may comprise a communication interface 38 which enables system 14 to communicate with other computers (e.g., with stakeholder systems 16-26, as well as with third-party computers 40, 42, 44). The interface 38 may comprise any suitable wire or wireless circuits, equipment, etc. which facilitate a land network connection (e.g., coax or triax cable, Ethernet cable, fire-wire, etc.) and/or wireless connection (e.g., including, at least in part, cellular, SRWC, DSRC, V2I, and the like). Thus, interface 38 may be coupled to any suitable Global System for Mobile communication (GSM) infrastructure, Long-Term Evolution (LTE) communication infrastructure, Code Division Multiple Access (CDMA) infrastructure, or the like (none of which are shown). These and other communication infrastructures, as well as techniques for interconnecting wired and wireless communication links, are known in the art.

Each of third-party computers 40, 42, 44 may comprise a suitable electronics device which is capable of wired and/or wireless two-way communication. Non-limiting examples of third-party computers 40, 42, 44 include cellular telephones, personal digital assistants (PDAs), Smart phones, laptops or tablet computers, netbook computers, telematics devices in fleet vehicles 12 (e.g., facilitating any suitable wireless communication), and the like. As will be explained in greater detail below, a third-party computer 40, 42, 44 may request (e.g., from fleet manager system 14) use of one or more of the vehicles 12, and when the stakeholder systems 14-26 approve the use, one of the stakeholder systems 14-26 (e.g., such as fleet manager system 14) may transmit an indication that the use is approved.

Stakeholder systems 14-26 each may execute a set of instructions (e.g., such as instructions 36 stored in memory 34 of computer 30) that enables the respective stakeholder systems 14-26 to operate as the communication network 10. According to one example, the network 10 is a peer-to-peer (P2P) network; however, other network arrangements are also possible (e.g., hub-and-spoke, mesh, etc.).

As discussed above, any request for use of vehicle(s) 12 may need to be approved by each of the systems 14-26. For example, if fleet manager system 14 receives a request from a third-party computer 40, 42, 44, then each stakeholder system 14-26 may be required to analyze the request using their respective vehicle usage policies. Each vehicle usage policy may comprise another set of computer-executable instructions. For example, in FIG. 1, instructions 50 (also storable in memory 34) comprise a vehicle usage policy unique to fleet manager system 14. As discussed above, instructions 50 may define criteria in which fleet manager system 14 approves or denies use of its fleet vehicles 12. Using instructions 50, fleet manager system 14 may determine vehicle availability, vehicle maintenance needs, and the like—and thus determine whether one or more requested fleet vehicles 12 may be used.

With respect to at least the communication network 10, each set of policy instructions (e.g., stored at respective stakeholder systems 14-26) may be unique. Accordingly, government entities, banking institutions, restaurants, florists, parcel delivery services, etc. each may have different predefined criteria which is used by the respective systems 16-26 to determine whether they each approve or deny a proposed vehicle use. For example, the government entity may approve use based on a type of proposed cargo to be transported by the vehicle 12 or based on a driving record of a proposed driver of the vehicle 12. Restaurants, florists, and other services which may deliver a product by vehicle 12 may be concerned with whether the vehicle 12 is properly equipped (e.g., with food warmers, refrigeration units, etc.). Delivery service entities may be concerned with when a delivery item will arrive at its destination (e.g., based on vehicle availability determined by fleet manager system 14). These are merely examples to illustrate unique criteria which may be associated with different sets of policy instructions stored in respective memories of systems 14-26 and executed by the respective processor(s) therein. Still other examples exist—some of which are set forth below (also by way of example only).

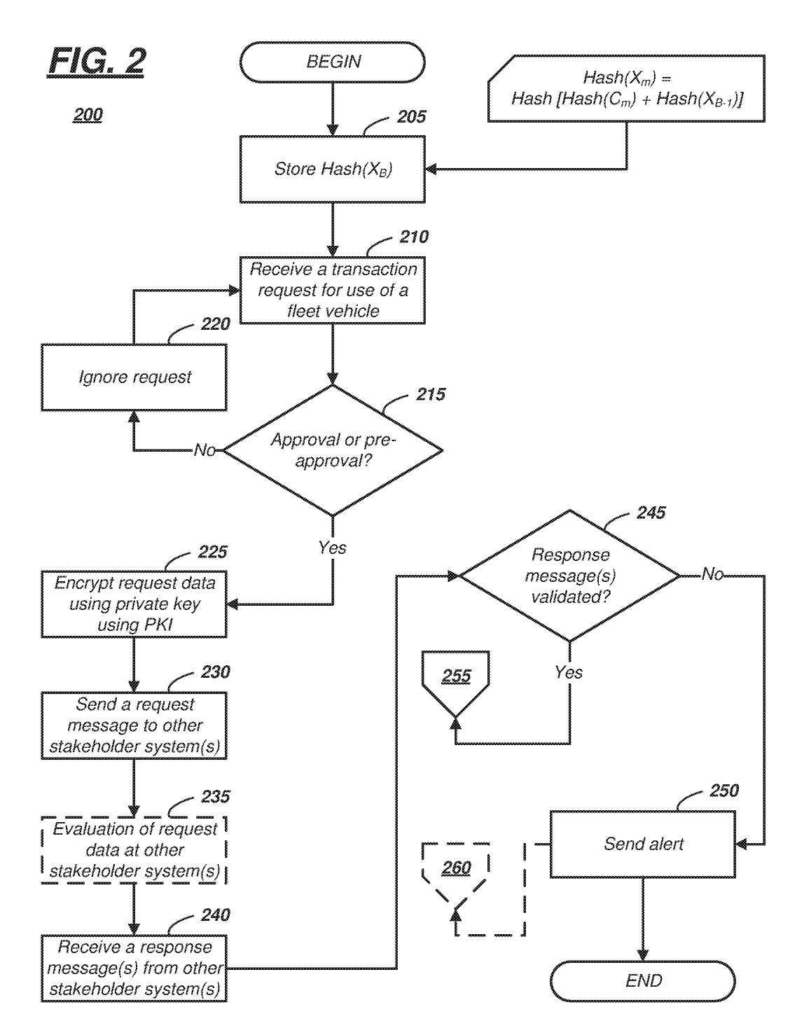

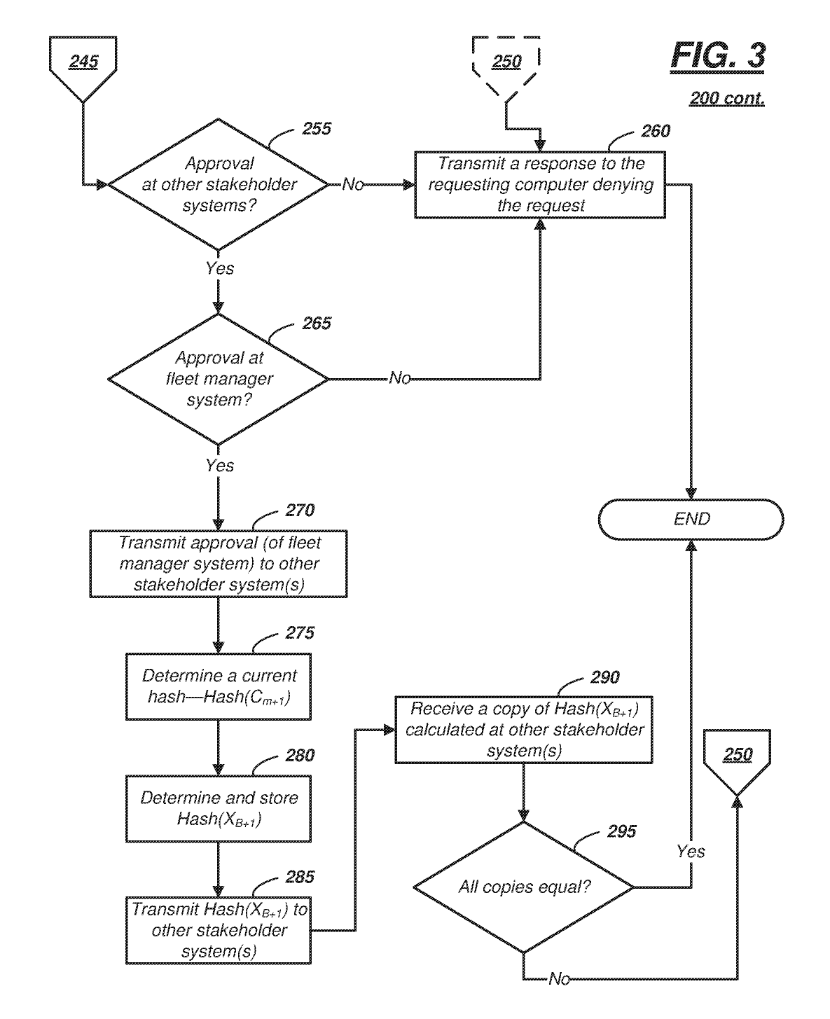

Turning now to a flow diagram illustrated in FIGS. 2-3, an illustrative process 200 is shown for generating and maintaining vehicle fleet records of the fleet manager system 14. More particularly, process 200 sets forth a number of instructional blocks which may be executed by the processor(s) 32 (of the fleet manager system 14) in order to generate and maintain fleet records. For example, process 200 may begin with block 205—e.g., wherein system 14 stores data (e.g., in memory 34) which is associated with both current and previous transactions processed by communication network 10. According to one example, the data is a hash (e.g., Hash(X_{B})) or encrypted information associated with a most-recent transaction m). E.g., see Equation (1).

Hash(X_{B})=Hash[Hash(Cₘ)+Hash(X_{B-1})], wherein Hash(Cₘ) may be a hash indicating that each of n stakeholders approved a most-recent transaction m, wherein Hash(X_{B-1}) may be a hash of a previously approved transaction m−1 (e.g., a next-most-recently approved transaction). Equation (1)

The remaining instructions of process 200 explain an illustrative example wherein a subsequent hash (e.g., Hash(X_{B+1})) may be generated; and accordingly, hashes Hash(X_{B-1}), Hash(X_{B}), and Hash(X_{B+1}) may represent a sequence of transactions (m−1, m, and m+1)−each of which are linked to another for purposes of security. More particularly, transactions m−, m, and m+1 are not only sequential, but in this example, the sequence comprises no intervening transactions. According to one example, each of hashes Hash(X_{B-1}), Hash(X_{B}), and Hash(X_{B+1}) are blocks in a so-called blockchain.

Accordingly, in block 210, fleet manager system 14 may receive a new transaction request for use of a vehicle 12 from its inventory of fleet vehicles—e.g., and for purposes of illustration, the transaction request will be referred to as transaction m+1 (i.e., a next transaction that follows transaction m). The request may be received from any suitable requesting computer. As used herein, a requesting computer is any computing system making a request, of fleet manager system 14, to utilize one or more fleet vehicles 12 owned and/or managed thereby. Thus, the requesting computer may be any one of third-party computer 40, third-party computer 42, third-party computer 44, one of stakeholder systems 14-26, or any other suitable computing device.

To illustrate, a user needing a ride may transmit a transaction request from his/her Smart phone 40 to system 14 (e.g., or even first to vehicle 12). Or for example, a user at a personal computer 42 may send a transaction request via a wired connection to system 14. Or for example, a user in vehicle 12 (or even a computer onboard vehicle 12 itself) may send a transaction request to fleet manager system 14. Non-limiting instances of an onboard computer within vehicle 12 sending such a request include a request for service or maintenance in response to a detected diagnostic trouble code. In other examples, one of the entities associated with network 10 may send a transaction request to system 14—e.g., a florist (system 20) may request a vehicle 12 to deliver flowers, a parcel delivery entity (system 22) may request a portion of the fleet of vehicles 12 to deliver packages during a holiday season, etc. These are merely examples; and other transaction requests may be sent and ultimately delivered to fleet manager system 14.

For purposes of illustrating process 200 only, a transaction request, from a user, requesting use of a vehicle to transport furniture will be described. The transaction request may comprise request data, and non-limiting examples of request data include: one or more of a desired vehicle type (e.g., make, model, features or amenities, etc.); a proposed vehicle use; a user identifier; a desired pick-up location (e.g., an address, global positioning system coordinates, or the like); a desired destination location (e.g., an address, global positioning system coordinates, or the like); a desired pick-up time (e.g., as used herein, a time includes calendar date and clock time); a desired destination arrival time; or the like. In some instances, the user identifier may be used by fleet manager system 14 to look-up additional user account information (e.g., stored in memory 34). For example, user account information may include a user name, contact information, the user identifier (e.g., account number, phone number, social security number, etc.), a user age or birthdate, user citizenship, user passport information, a user driver's license number, a user driver's operator license type, insurance information, driving record, etc. In other examples, a user may make the request as a guest (e.g., not having previously established an account).

By way of example only, the request data in the instant example may comprise a user identifier of a guest, a desired vehicle type (e.g., a full-size pick-up truck), a pick-up location (address A), a proposed destination location (address B), a proposed pick-up time (12:00 pm), and a proposed vehicle use (e.g., transporting the user and furniture).

Upon receiving the transaction request, in block 215, fleet manager system 14 may analyze its inventory of vehicles 12 and determine, in accordance with vehicle usage policy 50, whether the request can be approved by system 14 or at least pre-approved (e.g., conditionally approved). In some instances, the usage policy 50 additionally may require fleet manager system 14 to determine other criteria—e.g., such as whether the vehicle 12 may utilized by and/or operated by the particular user.

In some instances, the vehicle usage policy 50 may permit the fleet manager system 14 to approve (in block 215). In other instances, the instructions of policy 50 may permit system 14 only to conditionally approve—e.g., conditioned based on the information provided by other stakeholder systems 16-26 which have yet to review the request data. If the fleet manager system 14 can neither approve nor pre-approve the transaction request, then process 200 proceeds to block 220—else process 200 proceeds to block 225.

As discussed above, the vehicle usage policy 50 (of system 14) may be a set of instructions executed by system 14 each time it receives a transaction request. The instructions may include determining whether to approve (or pre-approve) based on previously scheduled uses (e.g., of the particular vehicle 12), whether to approve (or pre-approve) based on current geographic locations of vehicles 12 in the fleet inventory (e.g., and their proximity to a requested pick-up location (e.g., address A)), whether to approve (or pre-approve) based on traffic conditions (e.g., between an identified fleet vehicle 12 and address A), whether to approve (or pre-approve) based on vehicle service conditions (e.g., whether the identified vehicle 12 requires maintenance), and the like. Using criteria such as pick-up location, current or historical traffic conditions, and destination location, system 14 may determine an estimated duration of use of an identified vehicle 12 (i.e., a vehicle which matches the description or has the features requested by the user). Accordingly, fleet manager system 14 may determine, based on fleet demand, whether an identified fleet vehicle 12 having the desired features (e.g., a full-size pick-up truck) is available at the desired time and for the desired duration.

In addition, the policy 50 may dictate conditional override instructions. For example, although a particular fleet vehicle 12 may have a dent in its vehicle body (e.g., requiring maintenance or repair), returning the vehicle 12 for maintenance may be temporarily overridden based on the new transaction request. Continuing with the example above, when the user desires to haul freight (e.g., furniture) and the vehicle 12 has a small dent in the vehicle body, the policy 50 may determine, when no other suitable pick-up trucks are available, to override temporarily a previous service transaction request (e.g., to return the vehicle to a vehicle service center) and instead make the vehicle available for use by the requesting user.

In accordance with the exemplary policy instructions set forth above, system 14 may determine (in block 215) to approve. In other instances, alternative and/or additional policy instructions may be used—e.g., some of which may enable the system 14 (in block 215) only to pre-approve. For example, the policy 50 may include as prerequisite to approval, identifying and verifying the requesting user's driving record (per one or more law enforcement agencies), verifying the requesting user's ability to pay (e.g., according to a credit card transaction, electronic funds transfer, etc. via a banking institution, and the like). Thus, system 14 may conditionally approve (e.g., or pre-approve) when it has verified some usage criteria (e.g., vehicle availability within the fleet), but other usage criteria (e.g., driving record, ability to pay, etc.) may be verified by one or more other stakeholder systems 16-26. Continuing with the example set forth above, as the guest user does not have available account information stored at computer 30 of fleet manager system 14, then fleet manager system 14 may pre-approve (e.g., permitting exemplary law enforcement stakeholder system 16 to verify, among other things, whether the user may lawfully operate the requested vehicle 12).

Before discussing blocks 220 and 225, a few additional non-limiting examples of policy instructions 50 are set forth. For example, the fleet manager system 14 may verify any suitable vehicle usage (e.g., delivery of one or more persons, delivery of products (e.g., restaurant food, flowers, U.S. Mail, packages or parcels, groceries, any suitable large freight or other shipments requiring tractor-trailers, and/or the like)), driving as a service, etc. For any one or more vehicles 12 in the fleet, fleet manager system 14 may verify vehicle availability, government registration status, vehicle service status, and a vehicle driver status (e.g., including when drivers are previously registered with the fleet manager system 14). With regard to the latter, in some VaaS scenarios, a user may create an account and pre-register as a driver, and thereafter the user may facilitate the pick-up and delivery of other requesting users, their goods, etc. In some instances, the fleet manager system 14 may verify the return or return status of the vehicle 12 (e.g., after the requesting user uses the vehicle 12), and system 14 similarly may verify any suitable data regarding payment status. Any combination of these policy instructions 50, as well as like or other similar policy instructions, may be used.

The vehicle usage policy 50 of fleet manager system 14 also may be updated at times. However, it should be appreciated that the policy 50—for any current requested transaction—may be predefined. For example, once initiated, the transaction request sent by a user may be executed according to the policy 50 then in use. In at least some instances, a new block in a blockchain may be established at the time of a new policy implementation—i.e., the new block may record a transaction that a new policy—going forward—has been implemented.

Similarly, provided all stakeholder systems 14-26 concur, stakeholder systems may be added or deleted from the communication network 10 (e.g., each with a unique vehicle usage policy)—e.g., similarly, each change in the quantity of stakeholder systems may include recording the change by adding another block to a blockchain.

Turning now to block 220, when the fleet manager system 14 neither approves nor pre-approves the transaction request, the request may be ignored. Process 200 may loop back to block 210—e.g., receiving another transaction request (e.g., from the same or a different user). Alternatively, the ignored transaction request may be distributed to the other stakeholder system 16-26—and in accordance with the process described herein—a new block in a blockchain may be added (e.g., recording the denied transaction request). Regardless of whether the denied transaction request is recorded or not, no vehicle 12 may be approved for use by the requesting computer unless each of stakeholder systems 14-26 approve.

In block 225, when the fleet manager system 14 approves or pre-approves, then system 14 may prepare to send a request message (e.g., comprising some or all of the request data) to each of the other stakeholder systems 16-26. The request message may include additional information as well—e.g., information stored in a user's account, if such account is established. According to one example, the system 14 may encrypt request data and/or additional information using its private key—i.e., a private key that is unique to fleet manager system 14 (e.g., according to a PKI). With the request data as an input, the output may be a hash, as will be appreciated by those skilled in the art. Further, the request message may include the fleet manager system's public key and an unencrypted copy of the request data and/or any other encrypted information appended with the hash. In this manner, stakeholder systems 16-26 may validate that the request message was actually sent by the fleet manager system 14. As used herein, validation means that the recipient stakeholder system(s) in the communication network 10 (e.g., in this case, systems 16-26) may determine that the sending stakeholder system (e.g., in this instance fleet manager system 14) is legitimate and that the request message was not corrupted during transmission.

Once prepared, the fleet manager system (in block 230) may transmit the request message to stakeholder systems 16-26. This transmission may occur via communication network 10 and may be secure based on the characteristics of the PKI used. Secure communication between systems 14-26 (e.g., in blocks 225-230, as well as other instructional blocks described herein) may occur in other ways as well. Alternatively, or in combination with the example set forth above, fleet manager system 14 may transmit a secure message via a secure or private network (e.g., within the bounds of a firewall that includes each of the stakeholder systems 14-26). Again, alternatively, or in combination with the examples set forth above, fleet manager system 14 may transmit a secure message using a symmetric key infrastructure (e.g., instead of PKI). Other secure transmission techniques could be employed as well.

Block 235 which follows, is in phantom as it may be executed by systems 16-26. According to one example, each of systems 16-26 evaluate the request data sent by system 14. This may include each system 16-26 decrypting the request message, validating the request message, and analyzing the request data in accordance with their respective vehicle usage policies. As will be explained below, in order to grant the user's request, all stakeholder systems 14-26 may be required to approve; thus, if the respective policy of only one system 16-26 requires the respective system to disapprove, then there may be no need to have other systems evaluate.

In block 240 which follows, fleet manager system 14 may receive a plurality of response messages from stakeholder systems 16-26. According to one example, each response message is encrypted (and includes a message indicating approval or denial, a hash generated using the respective stakeholder system's private key, and a respective, corresponding public key).

In block 245 which follows, fleet manager system 14 may attempt to validate each of the response messages. As discussed above, system 14 may validate the messages using the public key respectively provided with each response message. When each of the response messages are validated, the process 200 may proceed to block 255 (see FIG. 3), discussed below.

When any one of the response messages are not validated (in block 245), then process 200 may proceed to block 250 generating an alert within the communication network 10 (e.g., indicating that a potential security breach has occurred). Following block 250, the process 200 may end. Alternatively, process 200 may proceed to block 260 (discussed below) and then end. In general, it is anticipated that an audit of transactions may be conducted to determine the origination and cause of any potential breach.

In block 255, fleet manager system 14 may determine whether each of the stakeholder systems 16-26 have approved—e.g., whether the message contained within the respective response messages indicated approval. According to one example, each response message approving the requested transaction may include a hash—e.g., so that the fleet manager system 14 may validate the respective approval (e.g., for illustration purposes, these hashes are denoted as Hash(Sₐ), Hash(Sₐ₊₁), Hash(Sₐ₊₂), . . . , Hash(Sₐ₊ₙ), wherein there are n stakeholder systems). If any of stakeholder systems 16-26 did not approve, then process 200 may proceed to block 260. If fleet manager system 14 determines that all stakeholder systems 16-26 approved, then process 200 may proceed to block 265.

In block 260, fleet manager system 14 may send a response to the requesting computer (and respective user) indicating that the request (of block 210) was denied. In some instances, a reason may be provided; however, this is not required. Thereafter, process 200 may end.

In block 265 which follows block 255, the fleet manager system 14 may determine—if not already done so—if the request from the requesting computer is approved in accordance with vehicle usage policy 50. For example, recall that in some instances, the process proceeded based on fleet manager system 14 pre-approving (in block 215). When in block 215, system 14 determined an approval, then process 200 may skip block 265 and proceed directly to block 270. However, when in block 215, the fleet manager system 14 pre-approved, then system 14 now may determine whether to approve or deny. Continuing with the example set forth above—wherein the user, via the computer 40, sent a request without having a pre-established account—the fleet manager system 14 may have waited to approve based on one or more criteria such as determining driving record information (e.g., from law enforcement system 16) and/or payment information (e.g., from banking system 18).

Continuing with the instant example, both systems 16 and 18 approved (block 255); thus, fleet manager system 14 may determine based on approval of systems 16 and/or 18 to approve accordingly. Alternatively, or in combination therewith, system 14 may determine to evaluate a respective user driving record and user banking information in view of its vehicle usage policy 50. For example, while the driving record determined by system 16 may be suitable to drive lawfully, the fleet manager system policy 50 may be more stringent. For instance, law enforcement system 16 may approve based on determining the requesting user/driver has 8 so-called driving points on his record, wherein a state limit may be 12 points. However, the policy 50 may designate an approval only when the requesting driver has a maximum of 5 points. Thus, in this example, system 14 may not approve the request, even though the law enforcement system 16 approved. These are merely examples of the fleet manager system's vehicle usage policy 50—other or additional criteria may be evaluated by the system 14 in block 265. When fleet manager system 14 approves, the process may proceed to block 270. When fleet manager system 14 does not approve, process 200 may proceed to block 260 (described above) and then end.

According to another example of the process carried out in illustrative blocks 230-265, computing efficiency may be improved by transmitting request messages a batch at a time (blocks 225, 230). A batch may comprise one or more messages. For example, system 14 may prepare and transmit a first batch of request messages to some (but not all) of stakeholder systems 16-26 and wait to receive corresponding response message(s) (blocks 245, 255). When no response message denies the requested vehicle use, then send another batch of request messages to different stakeholder systems. This process may be repeated until all stakeholder systems 16-26 provide a response message. However, at any time, if one of the response messages indicate a denial of the requested use of fleet vehicle 12, then no further request message batches may be sent. Thus, computing resources may be conserved—as encryption processing and transmission may be minimized, as in accordance with the agreement between stakeholder systems 14-26, the vehicle use is denied wholesale if a single system 14-26 disapproves the transaction request.

Additional computing efficiency may be achieved by transmitting request messages to particular systems (of systems 16-26) before others. For example, request messages may be sent first to stakeholder systems associated with law enforcement, user background checks, user driving record checks, user insurance information, etc. (e.g., systems 16, 18, 26). Similarly, request messages generally may be sent last to stakeholder systems having marginal or minimal interest in a particular transaction. Using the illustrated example, the florist stakeholder system 20, the mail or parcel delivery stakeholder system 22, and the restaurant stakeholder system 24 may have minimal interest in the user using a pick-up truck to haul furniture. Consequently, in this continuing example, systems 20, 22, 24 may be queried with request messages last.

While each system 16-26 may need to approve, fleet manager system 14 may utilize a predictive algorithm to determine a likelihood of approval of each respective system 16-26 (e.g., based on historical data or the like), and then system 14 may send request messages according to a determined priority sequence (i.e., send request messages first to those systems most likely to deny the requested use, thereby determining more quickly whether the request is likely to be approved unanimously).

Turning now to block 270 (which follows block 265), fleet manager system 14 may transmit an indication that it approves to the other systems 16-26. According to one example and continuing with the example set forth above, fleet manager system 14 may transmit to the other stakeholder systems 16-26 a hash as well (e.g., for illustration purposes, Hash(Sₐ₊_{_}), wherein Hash(Sₐ₊_{_}) comprises one of Hash(Sₐ), Hash(Sₐ₊₁), Hash(Sₐ₊₂), . . . , Hash(Sₐ₊ₙ)). This may be done so that each system 14-26 can store common data—e.g., a common set of approvals. According to one example, each stakeholder system 14-26 may store a copy of the approval hash in respective memory (e.g., system 14 stores a copy of its own approval hash, as well as the approval hashes of the other stakeholder systems 16-26 in memory 34).

Following block 270, in block 275, fleet manager system 14 may compose another message indicating that, with respect to the current transaction request, each stakeholder system 14-26 in the network 10 approves. According to one non-limiting example, this message is another hash (referred to herein as Hash(Cₘ₊₁), wherein m+1 identifies the current transaction request). Hash(Cₘ₊₁) may be defined by Equation (2), shown below. Hash(Cₘ₊₁) may be calculated using the symmetric key shared by each of the stakeholder systems 14-26, and the order of the input hashes (Hash(Sₐ), Hash(Sₐ₊₁), Hash(Sₐ₊₂), . . . ) may be predefined. In this manner, the resulting hash—i.e., Hash(Cₘ₊₁)—may be identical when calculated by each of the respective stakeholder systems 14-26.

Hash(Cₘ₊₁)=Hash[Hash(Sₐ)+Hash(Sₐ₊₁)+Hash(Sₐ₊₂)+ . . . +Hash(Sₐ₊ₙ)] Equation (2)

In block 280 which follows block 275, fleet manager system 14 may calculate Hash(X_{B+1})—i.e., system 14 may generate a new record which links the current transaction (m+1), to the previous transaction (m), to the transaction before that (m−1), etc. According to one example, this is determined using Equation (3), wherein the hash function again may utilize the symmetric key shared by each of the stakeholder systems 14-26 (e.g., so that Hash(X_{B+1}), executed by each of the systems 14-26, may be identical). Equation (3) is another example of using a blockchain to link records together—e.g., records of the approval of a current transaction request with previous records. Other manners of linking data records are also possible (e.g., including other ways of linking encrypted data).

Hash(X_{B+1})=Hash[Hash(Cₘ₊₁)+Hash(X_{B})] Equation (3)

Blocks 285-295 may facilitate additional validation within the network 10. For example, in block 285 which follows, a copy of the linked record (e.g., Hash(X_{B+1})) may be transmitted to the other stakeholder systems 16-26 to determine concurrence and validation among all systems 14-26 in the network 10.

In block 290, copies of the linked records (generated at each of the other stakeholder systems 16-26) may be received by system 14. Continuing with the example of above, a copy of the resulting hash of Equation (3)—executed individually by each of the other stakeholder systems 16-26—may be received by system 14.

In block 295 which follows, fleet manager system 14 may determine whether each copy is equal. For example, the system 14 may compare copies of the hashes (e.g., Hash(X_{B+1}))—from systems 16-26—to its own copy (e.g., Hash(X_{B+1})) and determine whether they are identical. When all copies are equal, the new record is validated and the process 200 ends. If all copies are not equal, then the process may proceed to block 250 (e.g., sending an alert, as described above).

In some examples of process 200, records are linked to another for each vehicle 12 in the fleet. In other examples, records regarding the fleet (or a portion of the fleet) are linked to another—regardless of a quantity of fleet vehicles involved in the specific transactions.

Thus, there has been described a communication network comprising a plurality of stakeholder systems. One of the stakeholder systems may manage a fleet of vehicles. When a request to use a vehicle in the fleet is received, each of the stakeholder systems may be required to approve. For each requested transaction—or for each approved transaction—a new record is generated. This new record is linked to a previous record (e.g., associated with a different vehicle transaction). According to one example, the new record is linked to a previous record using cryptography.

In general, the computing systems and/or devices described may employ any of a number of computer operating systems, including, but by no means limited to, versions and/or varieties of the Ford SYNC® application, AppLink/Smart Device Link middleware, the Microsoft® Automotive operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The processor is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. The processor may be programmed to process the sensor data. Processing the data may include processing the video feed or other data stream captured by the sensors to determine the roadway lane of the host vehicle and the presence of any target vehicles. As described below, the processor instructs vehicle components to actuate in accordance with the sensor data. The processor may be incorporated into a controller, e.g., an autonomous mode controller.

The memory (or data storage device) is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory may store data collected from sensors.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A method, comprising:
receiving, from a requesting computer, a current transaction request for use of at least one vehicle in a fleet;
determining that each of a plurality of stakeholder systems approves the request;
generating a new record indicating approval of the use by cryptographically linking the new record to a previous record associated with a different transaction request; and
sending an indication of approval to the requesting computer.

2. The method of claim 1, wherein the current transaction request is received by a fleet manager system, wherein the fleet manager system is one of the plurality.

3. The method of claim 1, wherein the new record and the previous record are part of a blockchain of records.

4. The method of claim 1, wherein the new record comprises a hash of: the previous record and data indicating an approval from each of the plurality.

5. The method of claim 4, wherein, with respect to the previous record, the new record is a next-most-recent record generated by the plurality.

6. The method of claim 1, wherein each of the plurality approve in accordance with a unique vehicle usage policy.

7. The method of claim 1, wherein a fleet manager system approves in accordance with a vehicle usage policy, wherein the fleet manager system is one of the plurality.

8. The method of claim 7, wherein the request identifies a vehicle model, wherein the policy includes determining whether a fleet inventory includes the model and whether the model is available.

9. The method of claim 7, wherein the request identifies a pick-up location and a pick-up time, wherein the policy includes determining whether one of a fleet inventory is capable of arriving at the pick-up location timely.

10. The method of claim 7, further comprising, in accordance with the policy, determining whether each of a fleet inventory includes up-to-date government vehicle registration.

11. The method of claim 7, further comprising determining whether a driving record of a user is in accordance with the policy.

12. A method, comprising:
storing, at a fleet manager system, a previous record associated with a previous transaction;
receiving, from a requesting computer, a transaction request for use of a fleet vehicle;
evaluating request data, from the transaction request, to determine whether it conforms to a vehicle usage policy;
transmitting, to at least one additional stakeholder system, a request message comprising at least some of the request data, wherein a plurality of stakeholders comprise the fleet manager system and the at least one additional stakeholder system;
determining that the plurality approves the request;
transmitting, to the requesting computer, a response indicating the request for use of the vehicle is approved; and
storing a new record based on a unanimous approval, wherein the new record is linked to the previous record.

13. The method of claim 12, wherein the new record and the previous record are part of a blockchain of records.

14. The method of claim 12, wherein the new record comprises a hash of: the previous record and data indicating an approval from each of the plurality.

15. The method of claim 14, wherein, with respect to the previous record, the new record is a next-most-recent record generated by the plurality.

16. The method of claim 12, wherein the request identifies a vehicle model, wherein the policy includes determining whether a fleet inventory includes the model and whether the model is available.

17. The method of claim 12, wherein the request identifies a pick-up location and a pick-up time, wherein the policy includes determining whether one of a fleet inventory is capable of arriving at the pick-up location timely.

18. The method of claim 12, further comprising, in accordance with the policy, determining whether each of a fleet inventory includes up-to-date government vehicle registration.

19. The method of claim 12, further comprising determining whether a driving record of a user is in accordance with the policy.

20. A fleet manager system, comprising:
a processor; and
memory storing instructions executable by the processor, the instructions comprising, to:
store, at a fleet manager system, a previous record associated with a previous transaction;
receive, from a requesting computer, a transaction request for use of a fleet vehicle;
evaluate request data, from the transaction request, to determine whether it conforms to a vehicle usage policy;
transmit, to at least one additional stakeholder system, a request message comprising at least some of the request data, wherein a plurality of stakeholders comprise the fleet manager system and the at least one additional stakeholder system;
determine that the plurality approves the request;
transmit, to the requesting computer, a response indicating the request for use of the vehicle is approved; and
store a new record based on a unanimous approval, wherein the new record is linked to the previous record.
